(19) United States
(12) Patent Application Publication
(10) Pub. No.: US 2020/0125042 A1
(43) Pub. Date: Apr. 23, 2020

(54) CONTROL SUPPORT DEVICE, APPARATUS CONTROL DEVICE, CONTROL SUPPORT METHOD, RECORDING MEDIUM, LEARNED MODEL FOR CAUSING COMPUTER TO FUNCTION, AND METHOD OF GENERATING LEARNED MODEL

(71) Applicant: TOYOTA JIDOSHA KABUSHIKI KAISHA, Toyota-shi (JP)

(72) Inventors: Hiroshi OYAGI, Gotemba-shi (JP); Tomohiro KANEKO, Mishima-shi (JP)

(73) Assignee: TOYOTA JIDOSHA KABUSHIKI KAISHA, Toyota-shi (JP)

(21) Appl. No.: 16/659,653

(22) Filed: Oct. 22, 2019

(30) Foreign Application Priority Data
Oct. 23, 2018 (JP) 2018-199266

(51) Int. Cl. G05B 13/02; G06N 3/04; G06N 3/08; G06F 17/16; G06F 17/13

(52) U.S. Cl. CPC G05B 13/027; G06N 3/04; G06F 17/13; G06F 17/16; G06N 3/08

(57) ABSTRACT

A control support device which supports control of an apparatus by using a learned model by machine learning, includes: a data acquisition unit acquiring an input/output data set which are data relating to an internal or external state of the apparatus and including input parameters and an output parameter of the learned model; a learning unit generating a learned model by performing the machine learning using the input/output data set acquired by the data acquisition unit; and a determination unit determining a learned model which is to be used for the control from among a plurality of learned models, which include a learned model having been completely generated and can be used for the control, based on the input parameters acquired by the data acquisition unit and a learning situation of the machine learning in the learning unit.

### CROSS-REFERENCE TO RELATED APPLICATION(S)

The present application claims priority to and incorporates by reference the entire contents of Japanese Patent Application No. 2018-199266 filed in Japan on Oct. 23, 2018.

### BACKGROUND

The present disclosure relates to a control support device, an apparatus control device, a control support method, a recording medium, a learned model for causing a computer to function, and a method of generating the learned model.

There has been known a technique of controlling an internal combustion engine by using a learned model by machine learning based on a neural network (see, for example, Japanese Laid-open Patent Publication No. 2012-112277). In this technique, the learned model is used to estimate the flow rate of gas in a predetermined passage of the internal combustion engine and control the internal combustion engine based on the estimation result.

### SUMMARY

There is a need for providing a control support device, an apparatus control device, a control support method, a recording medium, a learned model for causing a computer to function, and a method of generating the learned model, which can accurately support control of an apparatus using the learned model by machine learning.

According to an embodiment, a control support device which supports control of an apparatus by using a learned model by machine learning, includes: a data acquisition unit acquiring an input/output data set which are data relating to an internal or external state of the apparatus and including input parameters and an output parameter of the learned model; a learning unit generating a learned model by performing the machine learning using the input/output data set acquired by the data acquisition unit; and a determination unit determining a learned model which is to be used for the control from among a plurality of learned models, which include a learned model having been completely generated and can be used for the control, based on the input parameters acquired by the data acquisition unit and a learning situation of the machine learning in the learning unit.

According to an embodiment a apparatus control device is to communicate with a control support device, which is to support control of an apparatus, and control the apparatus by using a learned model by machine learning, the control support device including: a learning unit generating a learned model by performing the machine learning using an input/output data set which is data relating to an internal or external state of the apparatus and including input parameters and an output parameter of the learned model; and a determination unit determining a learned model used for the control from among a plurality of learned models that include a learned model, which has been completely generated, and can be used for the control, based on the input parameters and a learning situation in the learning unit, and the apparatus control device including: a data acquisition unit acquiring the input/output data set; and a communication unit transmitting the input/output data set acquired by the data acquisition unit to the control support device and receiving at least a determination result by the determination unit from the control support device.

According to an embodiment a control support method executed by a control support device to support control of an apparatus by using a learned model by machine learning, includes: a data acquisition step of acquiring an input/output data set which is data relating to an internal or external state of the apparatus and including input parameters and an output parameter of the learned model; a learning step of reading out from a storage unit the input/output data set acquired in the data acquisition step and generating a learned model by performing the machine learning using the input/output data set read out; and a determination step of determining a learned model used for the control from among a plurality of learned models that include a learned model, which has been completely generated, and can be used for the control, based on the input parameters acquired in the data acquisition step and a learning situation of the machine learning.

According to an embodiment, a non-transitory computer-readable recording medium stores a control support program causing a control support device, which is to support control of an apparatus by using a learned model by machine learning, to execute: a data acquisition step of acquiring an input/output data set which is data relating to an internal or external state of the apparatus and including input parameters and an output parameter of the learned model; a learning step of reading out from a storage unit the input/output data set acquired in the data acquisition step and generating a learned model by performing the machine learning using the input/output data set read out; and a determination step of determining a learned model used for the control from among a plurality of learned models that include a learned model, which has been completely generated, and can be used for the control, based on the input parameters acquired in the data acquisition step and a learning situation of the machine learning.

According to an embodiment, a learned model generated from a neural network includes: an input layer, into which input parameters obtained by quantifying an internal or external state of an apparatus are input; an intermediate layer, into which signals output by the input layer is input and which has a multilayer structure; and an output layer, into which signals output by the intermediate layer is input and which outputs an output parameter obtained by quantifying a predetermined state of the apparatus, in which each of the layers including one or a plurality of nodes. Further, the learned model causes a computer to function so as to input the input parameters into the input layer, perform an arithmetic operation based on a learned network parameter which is a network parameter of the neural network, and output a value obtained by quantifying a predetermined state of the apparatus from the output layer.

According to an embodiment, in a method of generating a learned model according to the present disclosure for generating a learned model for causing a computer to function so as to output a value obtained by quantifying a predetermined state of an apparatus, the computer uses a neural network, which includes an input layer into which input parameters obtained by quantifying an internal or external state of the apparatus are input; an intermediate layer, into which signals output by the input layer are input and which has a multilayer structure; and an output layer, into which signals output by the intermediate layer is input and which outputs an output parameter, in which each of the layers includes one or a plurality of nodes, to learn while updating a network parameter of the neural network based on the output parameter output by the output layer according to input of the input parameters and an output parameter constituting an input/output data set together with the input parameters and storing the network parameter in a storage unit.

### BRIEF DESCRIPTION OF THE DRAWINGS

FIG. 1 is a block diagram illustrating a functional configuration of a vehicle control device including a control support device according to a first embodiment;

FIG. 2 is a diagram schematically illustrating a configuration of a neural network learned by a learning unit;

FIG. 3 is a diagram illustrating an outline of input/output of nodes possessed by the neural network;

FIG. 4 is a flowchart illustrating an outline of processing performed by the vehicle control device including the control support device according to the first embodiment;

FIG. 5 is a diagram schematically illustrating a relationship between the total engine operating time and the engine friction;

FIG. 6 is a flowchart illustrating an outline of processing performed by a vehicle control device including a control support device according to a second embodiment;

FIG. 7 is a flowchart illustrating an outline of processing performed by a vehicle control device including a control support device according a modified example of the second embodiment;

FIG. 8 is a block diagram illustrating a functional configuration of a vehicle control device including a control support device according to a third embodiment;

FIG. 9 is a diagram schematically illustrating a map created by a map creation unit;

FIG. 10 is a flowchart illustrating an outline of processing performed by the vehicle control device including the control support device according to the third embodiment; and

FIG. 11 is a block diagram illustrating a functional configuration of a communication system provided with a control support device according to a fourth embodiment.

### DETAILED DESCRIPTION

In the technique of Japanese Laid-open Patent Publication No. 2012-112277, since the learned model learned at the time of vehicle production or vehicle development is mounted, variations of machine difference among actual vehicles may affect the control.

Therefore, it is considered that machine learning is performed by acquiring learning data while the vehicle is traveling. By using the learned model generated during actual vehicle traveling, it is expected to improve the accuracy of estimating and predicting the state of the vehicle, but it takes times to prepare the learning data necessary for generating the learned model.

Under such circumstances, there has been a demand for a technique that provides accurate support using a learned model by machine learning for an apparatus such as a vehicle.

Hereinafter, with reference to the accompanying drawings, modes for carrying out the present disclosure (hereinafter referred to as “embodiments”) will be described.

### First Embodiment

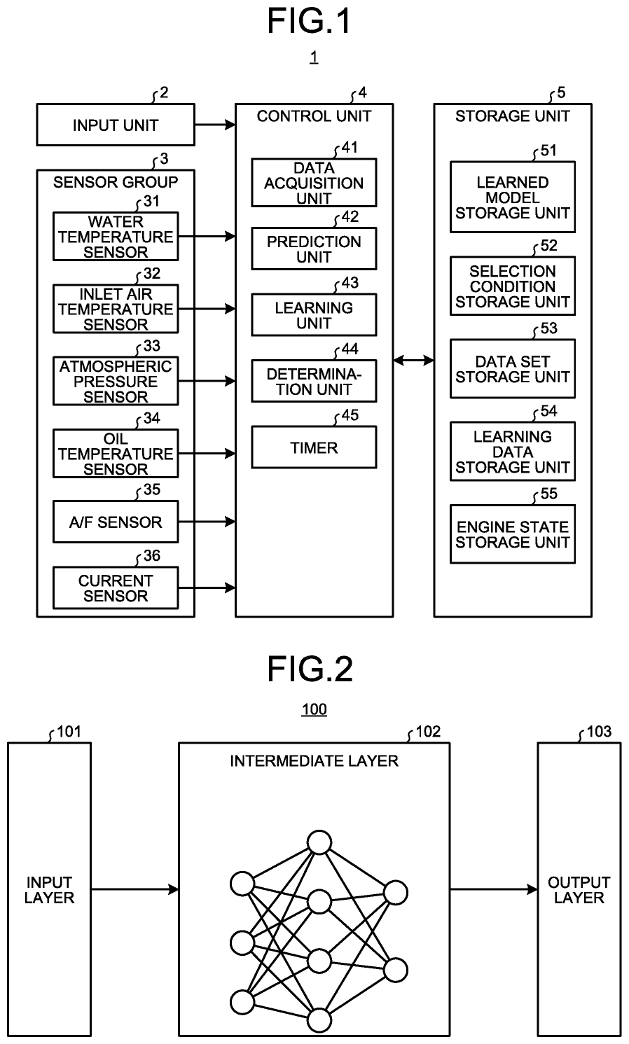

FIG. 1 is a block diagram illustrating a functional configuration of a vehicle control device including a control support device according to a first embodiment. A vehicle control device 1 illustrated in this drawing is a device that is mounted on a vehicle having an internal combustion engine and controls the operation of the vehicle as an apparatus. The vehicle control device 1 has an input unit 2, a sensor group 3, a control unit 4 and a storage unit 5. The vehicle control device 1 performs machine learning, in which predetermined data in environmental conditions and an engine state of the vehicle are input parameters and the power consumption necessary for restarting when idle reduction is performed on a vehicle (hereinafter may be simplified as “power consumption”) is an output parameter, to generate a learned model. Further, by using the learned model generated by the machine learning, the vehicle control device 1 predicts the power consumption necessary for restart after idle reduction.

The input unit 2 is constituted by using user interfaces such as a keyboard, a button for input, a lever, and a touch panel provided by being stacked on a display of liquid crystal or the like and accepts input of various pieces of information.

The sensor group 3 includes a water temperature sensor 31 that detects a water temperature (cooling water temperature) of engine cooling water, an inlet air temperature sensor 32 that detects an inlet air temperature for the engine, an atmospheric pressure sensor 33 that detects an atmospheric pressure, an oil temperature sensor 34 that detect an oil temperature for the engine, an A/F sensor 35 that detects the oxygen concentration in the exhaust gas, and a current sensor 36 that detects the state of charge of a battery.

The control unit 4 has a data acquisition unit 41, a prediction unit 42, a learning unit 43, a determination unit 44 and a timer 45. The control unit 4 is an electronic control unit (ECU) that electronically controls the vehicle.

The data acquisition unit 41 acquires the cooling water temperature, the inlet air temperature, the atmospheric pressure, the oil temperature, the oxygen concentration in the exhaust gas and the remaining battery level from the water temperature sensor 31, the inlet air temperature sensor 32, the atmospheric pressure sensor 33, the oil temperature sensor 34, the A/F sensor 35 and the current sensor 36, respectively. The data acquisition unit 41 calculates the fuel amount in oil by performing a predetermined arithmetic operation using the fuel injection amount controlled by the control unit 4 and the oxygen concentration in the exhaust gas acquired from the A/F sensor 35. The data acquisition unit 41 calculates the power consumption necessary for restart after idle reduction based on the time change in the state of charge of the battery acquired from the current sensor 36.

The data acquisition unit 41 writes an input/output data set in a data set storage unit 53 of the storage unit 5 to store. The input/output data set includes the cooling water temperature, the inlet air temperature, the atmospheric pressure, the oil temperature, the fuel amount in oil, the elapsed time after oil change, the total engine operating time, and the oil viscosity (or the viscosity grade) as input parameters, and the power consumption calculated for these input parameters as an output parameter. Among the input parameters, the elapsed time after oil change and the total engine operating time are each measured by the timer 45 and stored in an engine state storage unit 55 of the storage unit 5, and the oil viscosity (or the viscosity grade) is stored in the engine state storage unit 55 of the storage unit 5. Further, the data acquisition unit 41 writes the input parameters of the input/output data set in a learning data storage unit 54 of the storage unit 5 to store as the input parameters of the learning data. Note that the data acquisition unit 41 may acquire data on a cetane number and add the data to the input parameters when the internal combustion engine is a diesel engine.

The prediction unit 42 inputs the input parameters acquired by the data acquisition unit 41 into a predetermined learned model to calculate an output parameter obtained by quantifying the power consumption necessary for restart after idle reduction. The learned model used for the prediction unit 42 to quantify the power consumption will be described later.

The learning unit 43 performs machine learning based on the input/output data set acquired by the data acquisition unit 41. The learning unit 43 writes the learning results in a learned model storage unit 51 of the storage unit 5 to store. The learning unit 43 causes the learned model storage unit 51 of the storage unit 5 to store the latest learned model of a predetermined timing at the timing separately from the neural network being learned. To cause the learned model storage unit 51 to store, old learned models may be deleted to store the latest learned model, or the latest learned model may be stored while some or all the old learned models are being saved.

Hereinafter, deep learning using a neural network will be described as one example of specific machine learning. FIG. 2 is a diagram schematically illustrating a configuration of a neural network learned by the learning unit 43. A neural network 100 illustrated in this drawing is a feedforward neural network and has an input layer 101, an intermediate layer 102 and an output layer 103. The input layer 101 includes a plurality of nodes, and input parameters different from each other are input into each node. The intermediate layer 102 inputs the output from the input layer 101. The intermediate layer 102 has a multilayer structure including a layer composed of a plurality of nodes receiving the input from the input layer 101. The output layer 103 inputs the output from the intermediate layer 102 and outputs an output parameter. Machine learning using the neural network in which the intermediate layer 102 has a multilayer structure is called “deep learning”. In the first embodiment, the input parameters are “the cooling water temperature, the inlet air temperature, the atmospheric pressure, the oil temperature, the fuel amount in oil, the elapsed time after oil change, the total engine operating time, and the oil viscosity (or the viscosity grade),” and the output parameter is “the power consumption necessary for restart after idle reduction.”

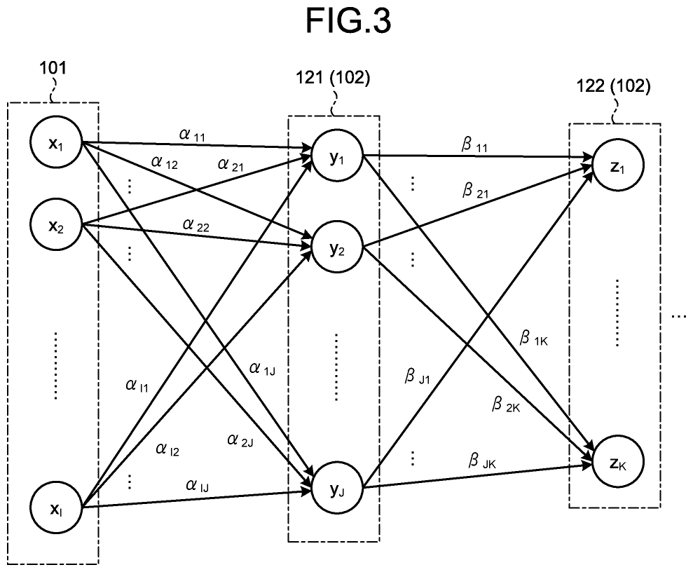

FIG. 3 is a diagram illustrating an outline of the input and output at the nodes possessed by the neural network 100. FIG. 3 schematically illustrates partial input/output of the data at the input layer 101 having I nodes, a first intermediate layer 121 having J nodes, and a second intermediate layer 122 having K nodes in the neural network 100 (I, J and K are positive integers). An input parameter xᵢ (i=1, 2, . . . , I) is input into the i-th node from the top of the input layer 101. Hereinafter, a set of all the input parameters will be referred to as “input parameters {xᵢ)}.”

Each node of the input layer 101 outputs a signal, which has a value obtained by multiplying an input parameter by a predetermined weight, to each node of the adjacent first intermediate layer 121. For example, the i-th node from the top of the input layer 101 outputs a signal, which has a value αᵢⱼxᵢ obtained by multiplying the input parameter xᵢ by the weight αᵢⱼ, to the j-th (j=1, 2, . . . , J) node from the top of the first intermediate layer 121. Into the j-th node from the top of the first intermediate layer 121, a value Σ_{i=1-I}αᵢⱼxᵢ+b⁽¹⁾ⱼ, which is obtained by adding a predetermined bias b⁽¹⁾j to the output from each node of the input layer 101 in total, is input. Herein, the first item Σ_{i=1-I} means the sum of i=1, 2, . . . , I.

An output value yⱼ of the j-th node from the top of the first intermediate layer 121 is expressed as yⱼ=S(Σ_{i=1-I}αᵢⱼxᵢ+b⁽¹⁾ⱼ) as a function of the input value Σ_{i=1-I}αᵢⱼxᵢ+b⁽¹⁾ⱼ from the input layer 101 to that node. This function S is called an “activation function”. Specific examples of the activation function include a sigmoid function S(u)=1/{1+exp(−u)} and a normalized linear function (ReLU)S(u)=max(0, u). A non-linear function is often used as the activation function.

Each node of the first intermediate layer 121 outputs a signal, which has a value obtained by multiplying an input parameter by a predetermined weight, to each node of the adjacent second intermediate layer 122. For example, the j-th node from the top of the first intermediate layer 121 outputs a signal, which has a value βⱼₖyⱼ obtained by multiplying an input value yⱼ by a weight βⱼₖ, to the k-th (k=1, 2, . . . , K) node from the top of the second intermediate layer 122. Into the k-th node from the top of the second intermediate layer 122, a value Σ_{j=1-J}βⱼₖyⱼ+b⁽²⁾ₖ, which is obtained by adding a predetermined bias b⁽²⁾ₖ to the output from each node of the first intermediate layer 121 in total, is input. Herein, the first item Σ_{j=1-J} means the sum of j=1, 2, . . . , J.

An output value zₖ of the k-th node from the top of the second intermediate layer 122 is expressed as zₖ=S(Σ_{j=1-J}βⱼₖyⱼ+b⁽²⁾ₖ) by using an activation function in which the input value Σ_{j=1-J}βⱼₖyⱼ+b⁽²⁾ₖ from the first intermediate layer 121 to that node is a variable.

Thus, one output parameter Y is finally output from the output layer 103 by sequentially repeating along the forward direction from the input layer 101 side toward the output layer 103 side. Hereinafter, the weights and biases included in the neural network 100 are collectively called a “network parameter w”. This network parameter w is a vector having all the weights and biases of the neural network 100 as components.

The learning unit 43 performs an arithmetic operation to update the network parameter based on the output parameter Y calculated by inputting the input parameter {xᵢ} into the neural network 100, and an output parameter (target output) Y₀ that constitutes the input/output data set together with the input parameter {xᵢ}. Specifically, the network parameter w is updated by performing an arithmetic operation to minimize an error between the two output parameters Y and Y₀. At this time, the stochastic gradient descent is often used. Hereinafter, a set ({xᵢ}, Y) of the input parameter {xᵢ)} and the output parameter Y will be generically referred to as “learning data”.

Hereinafter, the outline of the stochastic gradient descent will be described. The stochastic gradient descent is a method of updating the network parameter w so as to minimize a gradient ∇_{w}E(w) obtained from the derivative for each component of the network parameter w of an error function E(w) defined by using the two output parameters Y and Y₀. The error function is defined by, for example, the squared error |Y−Y₀|² of the output parameter Y of the learning data and the output parameter Y₀ of the input/output data set. Moreover, the gradient ∇_{w}E(w) is a vector having, as the components, derivatives ∂E(w)/∂αᵢⱼ, ∂E(w)/∂βⱼₖ, ∂E(w)/∂b⁽¹⁾ⱼ and ∂E(w)/∂b⁽²⁾ₖ (herein i=1 to I, j=1 to J and k=1 to k) relating to the components of the network parameter w of the error function E(w).

In the stochastic gradient descent, the network parameter w is sequentially updated to w′=w−η∇_{w}E(w), w″=w′−η∇_{w}·E(w′) and so on by using a predetermined learning rate r determined automatically or manually. Note that the learning rate q may be changed during learning. The learning unit 43 repeats the above-described update processing each time the data acquisition unit 41 acquires the learning data. Accordingly, the error function E(w) gradually approaches the minimum point. Note that, in a case of more general stochastic gradient descent, the error function E(w) is defined for each update processing by being extracted randomly from samples including all learning data and can also be applied to this first embodiment. The number of learning data extracted at this time is not limited to one and may be a part of the learning data stored in the learning data storage unit 54.

An error back propagation method is known as a method for efficiently performing the computation of the gradient ∇_{w}E(w). The error back propagation method is a method of calculating the learning data ({xᵢ)}, Y) and then computing the components of the gradient ∇_{w}E(w) reversely following the order of the output layer, the intermediate layer and the input layer based on the error between the target output Y₀ and the output parameter Y in the output layer. The learning unit 43 calculates all the components of the gradient ∇_{w}E(w) by using the error back propagation method and then applies the above-described stochastic gradient descent using the calculated gradient ∇_{w}E(w), thereby updating the network parameter w.

The determination unit 44 refers to the storage unit 5 to determine a learned model used for the prediction unit 42 to predict the power consumption. The determination unit 44 refers to the selection condition of the learned model stored in the storage unit 5, the input/output data set, the learning data and the like to determine whether the learning situation in the learning unit 43 meets a specified switching condition. The determination unit 44 selects the use of a first learned model when the switching condition is not met, and selects the use of a second learned model when the switching condition is met. Specific examples of the switching condition include the condition that “the learning data with a predetermined score (e.g., 100 points) is acquired when the cooling water temperature among the input parameters is in a predetermined temperature range (e.g., −10 to 90° C.).”

The timer 45 measures the time necessary for the processing of the control unit 4. The timer 45 measures, for example, the elapsed time after oil change necessary to perform machine learning, and the total engine operating time. When the control unit 4 acquires information on the oil change, the timer 45 resets the elapsed time after the oil change being measured. The measurement result of the timer 45 is stored in the engine state storage unit 55 of the storage unit 5.

The control unit 4 is a processor constituted by, for example, alone or in combination, a general-purpose processor such as a central processing unit (CPU), and/or hardware, such as a dedicated integrated circuit including a field programmable gate array (FPGA) or the like, that executes a specific function. By reading various programs stored in the storage unit 5, the control unit 4 executes various pieces of arithmetic operation processing for causing the vehicle control device 1 to operate.

The storage unit 5 has the learned model storage unit 51, a selection condition storage unit 52, the data set storage unit 53, the learning data storage unit 54 and the engine state storage unit 55.

The learned model storage unit 51 stores a learned model obtained by machine learning in advance in a laboratory at a stage of manufacturing the vehicle, developing the vehicle or the like (hereinafter referred to as the “first learned model”), and a learned model generated by learning of the learning unit 43 of the control unit 4 (hereinafter referred to as the “second learned model”). The first and second learned models are learned models generated based on deep learning using the same neural network. Storing the learned models means to store information on the network parameters, algorithm of the arithmetic operation and the like in the learned models. The learned model storage unit 51 stores the network parameter in the process of generating the second learned model by the learning unit 43 while sequentially updating the network parameter. Moreover, the learned model storage unit 51 stores the second learned model, which is constituted by using the latest network parameter at a predetermined timing in the process where the learning unit 43 is learning, as the second learned model that has been completely generated at that timing. The learned model storage unit 51 may store only the latest second learned model that has been completely generated or may store some or all of the plurality of second learned models that have been completely generated at the respective timings. Note that, to the second learned models, ones obtained by increasing the number of nodes in a certain layer of the intermediate layer in the course of generating the first learned model, or ones obtained by transfer learning by increasing the number of layers may be applied. Furthermore, the learned model storage unit 51 may store other learned models that can be used for the control of the vehicle.

The selection condition storage unit 52 stores the conditions for selecting a learned model used for the prediction unit 42 of the control unit 4 to predict the power consumption. The selection condition storage unit 52 stores, as a specific selection condition, a switching condition for switching from the first learned model to the second learned model. The switching condition can be regarded as the precision with which the latest second learned model that has been completely generated by the learning unit 43 can be reliable, and corresponds to a condition that can switch the learned model used by the prediction unit 42 to the second learned model.

The data set storage unit 53 stores the input/output data set composed of the set of the input parameters and output parameter described above. As described above, in the first embodiment, the input parameters are “the cooling water temperature, the inlet air temperature, the atmospheric pressure, the oil temperature, the fuel amount in oil, the elapsed time after oil change, the total engine operating time, and the oil viscosity (or the viscosity grade),” and the output parameter is “the power consumption necessary for restart after idle reduction.”

The learning data storage unit 54 stores, as the learning data, the output parameter Y, which is calculated by inputting the input parameter {xᵢ} into the neural network 100 by the learning unit 43, together with the input parameter {xᵢ}.

The engine state storage unit 55 stores the elapsed time after oil change and the total engine operating time measured by the timer 45. Further, the engine state storage unit 55 stores information on the oil viscosity or viscosity grade which the input unit 2 has accepted the input.

The storage unit 5 is constituted by using a volatile memory such as a random access memory (RAM) and a nonvolatile memory such as a read only memory (ROM). Note that the storage unit 5 may be constituted by using a computer readable recording medium such as a memory card that can be attached from the outside. The storage unit 5 stores various programs for executing the operation of the vehicle control device 1. The various programs also include a control support program according to the first embodiment. These various programs can also be distributed widely by being recorded on a computer readable recording medium such as a hard disk, a flash memory, a CD-ROM, a DVD-ROM or a flexible disk.

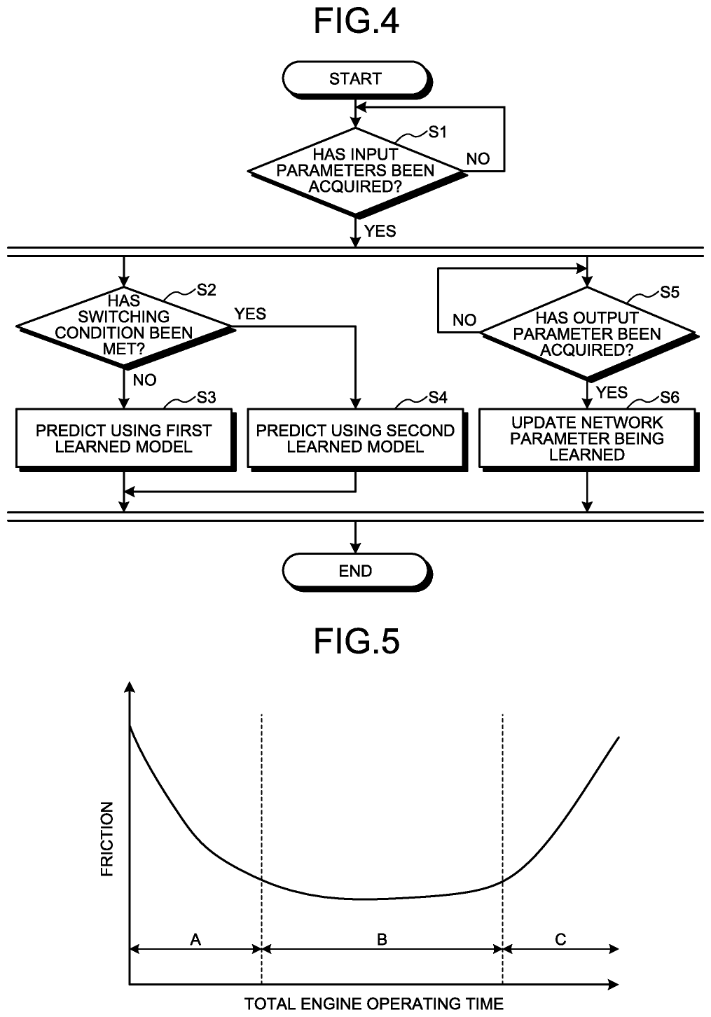

FIG. 4 is a flowchart illustrating an outline of processing performed by the vehicle control device 1. When the data acquisition unit 41 has acquired the input parameters (Step S1: Yes), the determination unit 44 determines whether the learning situation of the learning unit 43 meets the predetermined switching condition (Step S2). When the determination unit 44 determines that the switching condition is not met (Step S2: No), the prediction unit 42 uses the first learned model to perform an arithmetic operation of predicting the power consumption necessary for restart after idle reduction (Step S3).

When the determination unit 44 determines in Step S2 that the switching condition is met (Step S2: Yes), the prediction unit 42 uses the second learned model to perform an arithmetic operation of predicting the power consumption necessary for restart after idle reduction (Step S4).

When the data acquisition unit 41 does not acquire the input parameters in Step S1 (Step S1: No), the vehicle control device 1 repeats Step S1.

In the vehicle control device 1, the learning unit 43 performs machine learning using the neural network 100 in parallel with the processing of Steps S2 to S4. In a case where the data acquisition unit 41 has acquired the input parameters in Step S1 (Step S1: Yes), when the data acquisition unit 41 has acquired the output parameter (Step S5: Yes), the learning unit 43 uses the acquired input/output data set to update the network parameter being learned (Step S6). Specifically, by applying the above-described stochastic gradient descent and error back propagation method, the learning unit 43 inputs the input parameters among the acquired input/output data set into the neural network being learned to calculate the output parameter and updates the network parameter by using this output parameter and the target output of the input/output data set. The output parameter calculated by the learning unit 43 is stored in the learning data storage unit 54 together with the corresponding input parameters. Moreover, the network parameter updated by the learning unit 43 is stored in the learned model storage unit 51.

After the end of processing of Step S3 or S4 and Step S6, the vehicle control device 1 ends the series of processing.

The vehicle control device 1 executes the above processing at predetermined time intervals. Note that the second learned model is constantly updated in the above description, but the learning processing by the learning unit 43 may be stopped when the determination unit 44 determines that the switching condition is met in Step S2 (Step S2: Yes). Moreover, the learning processing by the learning unit 43 may not be performed in parallel with the prediction processing by the prediction unit 42. For example, the learning unit 43 may intermittently perform the learning processing each time an input/output data set with a predetermined score is accumulated.

In a case where an idle reduction condition is established, the vehicle control device 1 carries out the idle reduction when the power consumption predicted by the prediction unit 42 is equal to or less than the remaining battery level in the vehicle. On the other hand, even if the idle reduction condition is established, the vehicle control device 1 does not carry out the idle reduction when the power consumption predicted by the prediction unit 42 is greater than the remaining battery level in the vehicle. Examples of the idle reduction condition include “the vehicle is stopped” and “the brake is stepped on.” Note that the value of the remaining battery level compared with the power consumption may be a value smaller than the actual remaining battery level by a predetermined amount in consideration of safety.

According to the first embodiment described above, the learned model is generated by performing machine learning using an input/output data set relating to the internal or external state of the vehicle having the internal combustion engine, and, based on the acquired input parameters and the learning situation of the machine learning, a learned model used for the control of the vehicle is determined from a plurality learned models that include a learned model, which has been completely generated, and can be used for the control so that it is possible to accurately support the control of the vehicle having the internal combustion engine in which the control uses the learned model by the machine learning.

Moreover, in the first embodiment, when the second learned model learned by the learning unit while the vehicle is traveling meets the predetermined switching condition, the model is switched to the second learned model to predict the power consumption necessary for restart after idle reduction so that it is possible to improve the prediction precision of the power consumption by using a more appropriate learning model.

Furthermore, according to this first embodiment, since it is possible to improve the prediction precision of the power consumption necessary for restart after idle reduction, a predetermined level can be decreased when the remaining battery level compared with the power consumption during the control is lowered by the predetermined level. As a result, the number of idle reductions can be increased.

First Modified Example of First Embodiment

Due to the characteristics of the neural network, if there is a variation in the acquisition frequency of the learning data, nodes may be used for the learning of a region where the acquisition frequency is relatively high and the prediction precision may be decreased in a region where the acquisition frequency is relatively low. In a first modified example of the first embodiment, the score of the learning data in the region where the acquisition frequency of the learning data is higher than a predetermined reference is reduced.

FIG. 5 is a diagram schematically illustrating the relationship between the total engine operating time, which is one example of the input parameters to which the first modified example is applied, and the engine friction. As illustrated in FIG. 5, the engine friction with respect to the total engine operating time goes through a decreasing period A in which the engine friction decreases with the passage of time, and then a stable period B taking a substantially constant value for a relatively long time, and reaches an increasing period C in which the value increases. The acquisition frequency of the learning data in the stable period B is higher than the acquisition frequency in the decreasing period A or the increasing period C.

In such a case, the learning unit 43 performs deep learning by reducing the score of the learning data in the stable period B. For example, when the input parameters other than the total engine operating time are within a predetermined range from the learned input parameters in the stable period B, the learning unit 43 does not perform any further learning to decrease the score of the learning data in the stable period B. Note that, similar to the total engine operating time, the score of the learning data in the stable period B may also be decreased for the cooling water temperature.

According to this first modified example, even when there is a variation in the acquisition frequency of the learning data, by decreasing the score of the learning data in the region where the acquisition frequency is higher than the reference, the nodes of the neural network are also used for the learning of the region where the acquisition frequency is equal to or less than the reference, and it is possible to suppress the decrease in the prediction precision in the region where the acquisition frequency is equal to or less than the reference. Note that this first modified example can also be applied to the embodiments shown hereinafter.

Second Modified Example of First Embodiment

The learning unit 43 may generate a third learned model by updating the network parameter of the first learned model in parallel with generating the second learned model. In this case, the selection condition storage unit 52 may further store another switching condition, and the determination unit 44 can select the third learned model. According to this second modified example, it is possible to support the control of the vehicle by selecting an appropriate learned model from more various learning models. Note that this second modified example can also be applied to the embodiments shown hereinafter.

### Second Embodiment

The configuration of a vehicle control device according to a second embodiment is similar to the configuration of the vehicle control device 1 described in the first embodiment. However, in the second embodiment, the selection condition stored in a selection condition storage unit 52 is different. Hereinafter, components having the similar functions to the components of the vehicle control device 1 described in the first embodiment will be denoted by the same reference signs as that of the components of the vehicle control device 1 to be described.

The selection condition in this second embodiment is that a second learned model that has been completely generated by a learning unit 43 is used in a case where the condition that at least any one of input parameters acquired by a data acquisition unit 41 guarantees the prediction precision higher than a reference, that is, an interpolation condition is met, and a first learned model is used in other cases. More specifically, the interpolation condition is that at least any one of the input parameters acquired by the data acquisition unit 41 is data having a value within a range acquired during learning by the learning unit 43. When a learned model storage unit 51 stores a plurality of second learned models which have been completely generated by the learning unit 43, the optimum model may be selected from among the second learned models according to the interpolation condition, or the latest model among the second learned models may be selected. Note that, among the input parameters, the elapsed time after oil change and the total engine operating time are excluded from the interpolation condition because there are few rapid changes.

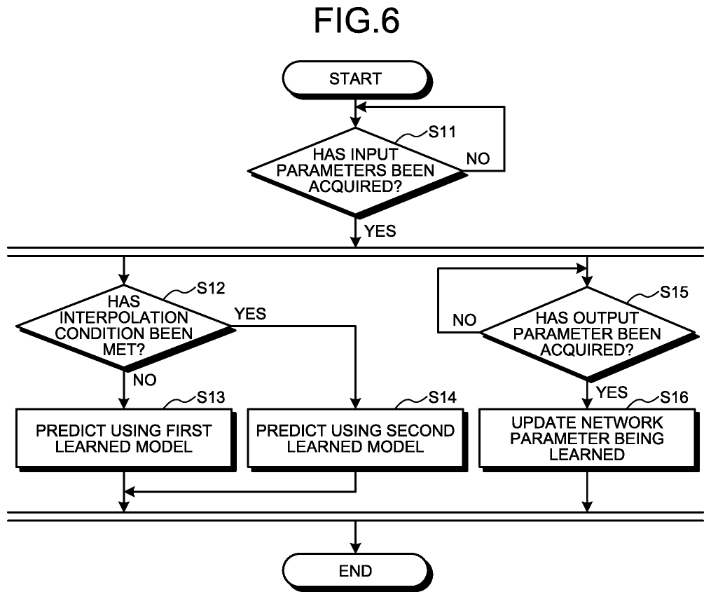

FIG. 6 is a flowchart illustrating an outline of processing executed by the vehicle control device according to the second embodiment. In FIG. 6, the processing of Steps S11 and S13 to S16 excluding Step S12 correspond to the processing of Steps S1 and S3 to S6 illustrated in FIG. 4, respectively. In Step S12, a determination unit 44 determines whether the input parameters meet the above-described interpolation condition as the selection condition of the learned model. When the determination unit 44 determines that the interpolation condition is not met (Step S12: No), a prediction unit 42 uses the first learned model to predict the power consumption (Step S13). On the other hand, when the determination unit 44 determines that the interpolation condition is met (Step S12: Yes), the prediction unit 42 uses the second learned model to predict the power consumption (Step S14).

In the case of the processing described above, whether the interpolation condition is met changes each time the data acquisition unit 41 acquires the input parameters. Thus, for example, the determination unit 44 may possibly determine the use of the first learned model again after determining the use of the second learned model. This is different from the first embodiment in which, once the determination unit 44 uses the second learned model, the prediction is always performed using the second learned model thereafter.

According to the second embodiment described above, similar to the first embodiment, it is possible to accurately support the control of a vehicle having an internal combustion engine in which the control uses the learned model by machine learning.

Moreover, according to this second embodiment, due to the characteristics of the neural network, when the input parameters within a predetermined range with respect to the set of the learning data meet the interpolation condition, the learned model used for the prediction can be switched to the second learned model even if the score of the learning data is low.

Furthermore, according to this second embodiment, by using the interpolation condition as the selection condition for the determination unit 44 to determine, the second learned model generated by the learning unit 43 can be used more quickly than the first embodiment.

Modified Example of Second Embodiment

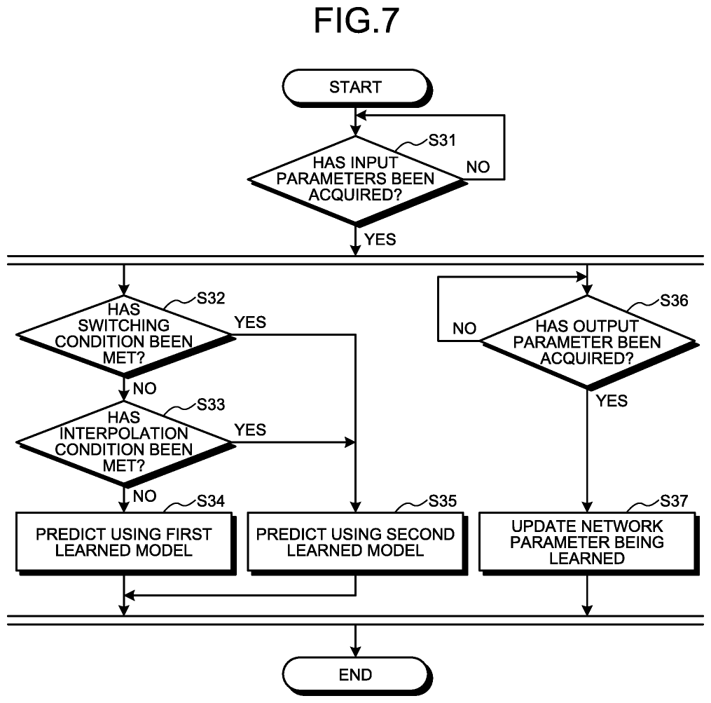

FIG. 7 is a flowchart illustrating the outline of the processing executed by a vehicle control device according to a modified example of the second embodiment. In this modified example, after the data acquisition unit 41 has acquired the input parameters (Step S31: Yes), the determination unit 44 determines whether the switching condition described in the first embodiment is met (Step S32). When the switching condition is not met (Step S32: No), the determination unit 44 determines whether the interpolation condition is met (Step S33). When the interpolation condition is not met (Step S33: No), the prediction unit 42 uses the first learned model to performs an arithmetic operation to predict the power consumption necessary for restart after idle reduction (Step S34).

When the switching condition is met in Step S32 (Step S32: Yes) or when the interpolation condition is met in Step S33 (Step S33: Yes), the prediction unit 42 uses the second learned model to perform an arithmetic operation to predict the power consumption necessary for restart after idle reduction (Step S35).

The processing of Steps S36 and S37 executed in parallel with Steps S32 to S35 correspond to the processing of Steps S5 and S6 described in the first embodiment, respectively.

According to this modified example, a learned model is selected based on the interpolation condition until the switching condition is met, and the second learning model generated by the learning unit 43 is selected when the switching condition is met. Thus, the prediction precision of the power consumption can be improved.

### Third Embodiment

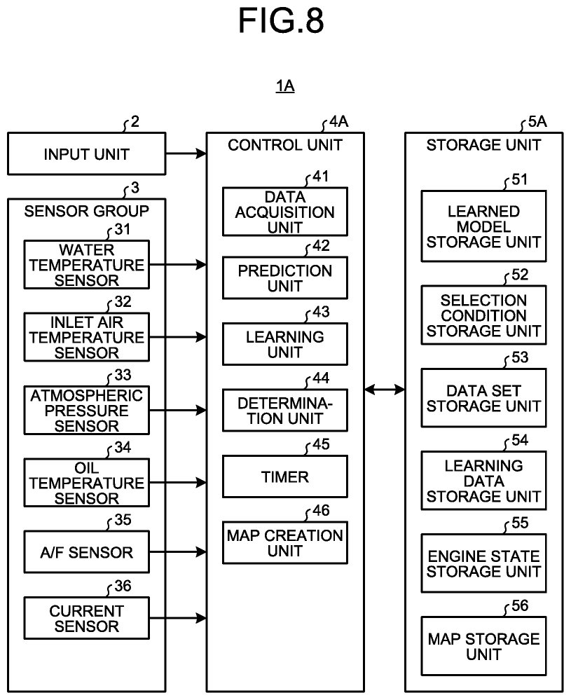

FIG. 8 is a block diagram illustrating the functional configuration of a vehicle control device including a control support device according to a third embodiment. A vehicle control device 1A illustrated in this drawing is an apparatus that is mounted on a vehicle and controls the operation of the vehicle. The vehicle control device 1A has an input unit 2, a sensor group 3, a control unit 4A and a storage unit 5A. Hereinafter, components having the similar functions to the components of the vehicle control device 1 described in the first embodiment will be denoted by the same reference signs as that of the components of the vehicle control device 1 to be described.

The control unit 4A has a data acquisition unit 41, a prediction unit 42, a learning unit 43, a determination unit 44, a timer 45 and a map creation unit 46. The control unit 4A is a processor constituted by, alone or in combination, a CPU and/or hardware such an FPGA.

The storage unit 5A has a learned model storage unit 51, a selection condition storage unit 52, a data set storage unit 53, a learning data storage unit 54, an engine state storage unit 55 and a map storage unit 56. The storage unit 5A is constituted by using hardware such as a ROM and a RAM.

In this third embodiment, the prediction unit 42 refers to a map possessed by the map storage unit 56 to perform an arithmetic operation to predict the power consumption necessary for restart after idle reduction. The map herein indicates the relationship between the input parameters and the output parameter created based on the learned model. For example, the output parameter is defined by a predetermined function f(xᵢ, x₂, . . . , x_{I}) in which the input parameters (x₁, x₂, . . . , xᵢ) (I is a positive integer) are variables. Hereinafter, the map created based on a first learned model is called a “first map”.

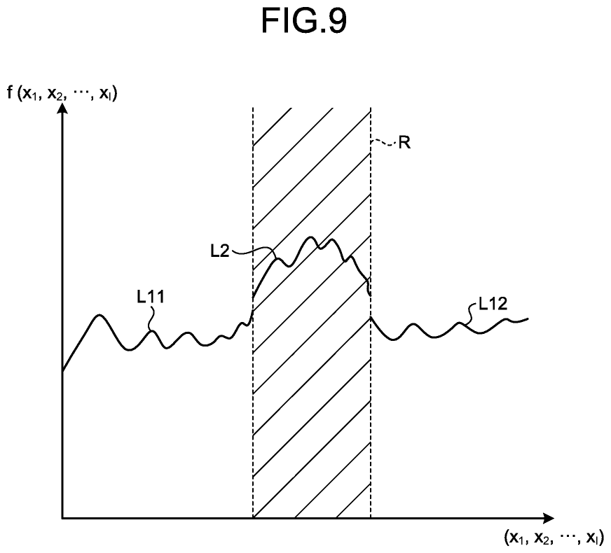

When the determination unit 44 determines that a switching condition is met, the map creation unit 46 creates a map (hereinafter referred to as a “second map”) based on a second learned model learned by the learning unit 43. FIG. 9 is a diagram schematically illustrating the second map created by the map creation unit 46. The second map illustrated in this drawing schematically represents an I-dimensional space composed of a set of input parameters (x₁, x₂, . . . , x_{I}) on the horizontal axis in one dimension and represents output parameters f (x₁, x₂, . . . , x_{I}) defined by a function f with these input parameters as variables on the vertical axis. A shaded area R in the map indicates a region where the function f is defined based on the second learned model. That is, curves L11 and L12 in the map are curves indicating a map created based on the first learned model while a curve L2 is curve indication a map created based on the second learned model. Note that the maps are described using the continuous curve in FIG. 9 for convenience of explanation, but the maps do not have to be continuous.

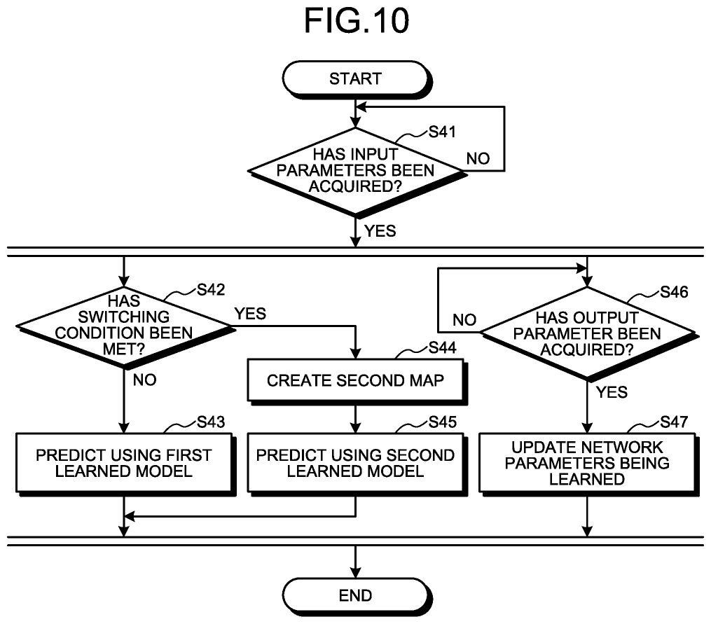

FIG. 10 is a flowchart illustrating an outline of processing executed by the vehicle control device 1A. When the data acquisition unit 41 has acquired the input parameters (Step S41: Yes), the determination unit 44 determines whether the learning situation of the learning unit 43 meets a predetermined switching condition (Step S42). When the determination unit 44 determines that the switching condition is not met (Step S42: No), the prediction unit 42 uses the first map to performs an arithmetic operation to predict the power consumption necessary for restart after idle reduction (Step S43).

When the determination unit 44 determines that the switching condition is met in Step S42 (Step S42: Yes), the map creation unit 46 uses the first map and the second learned model to create the second map (Step S44). Thereafter, the prediction unit 42 uses the second map to perform an arithmetic operation of predicting the power consumption necessary for restart after idle reduction (Step S45).

The processing of Steps S46 and S47 executed in parallel with Steps S42 to S45 correspond to the processing of Steps S5 and S6 described in the first embodiment, respectively.

According to the third embodiment described above, similar to the first embodiment, it is possible to accurately support the control of a vehicle having an internal combustion engine in which the control uses the learned model by machine learning.

Moreover, according to this third embodiment, since the prediction unit 42 calculates the output parameters by using the map, it is possible to predict the power consumption necessary for restart after idle reduction more quickly than a case of using the neural network.

Note that the region in the map may be subdivided to sequentially update the maps for each region meeting the switching condition. Accordingly, it is possible to further incorporate the learning results of the learning unit 43 earlier and predict the power consumption necessary for restart after idle reduction.

Furthermore, the selection condition referred to by the determination unit 44 to determine may be the interpolation condition described in the second embodiment or may be a combination of the switching condition and the interpolation condition described in the modified example of the second embodiment.

### Fourth Embodiment

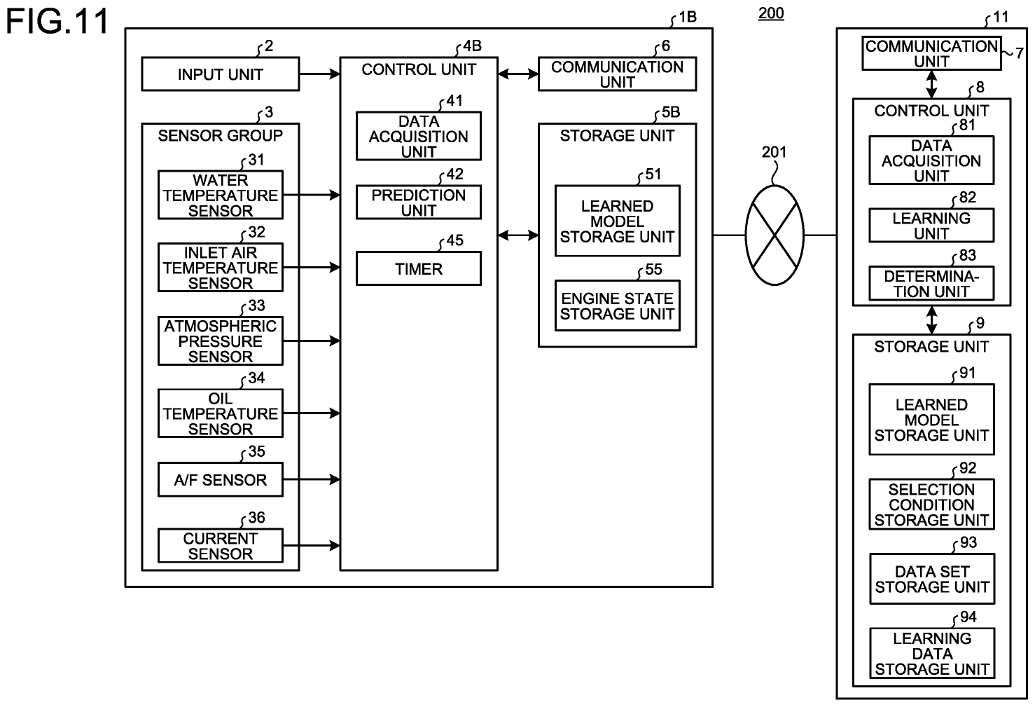

FIG. 11 is a block diagram illustrating a functional configuration of a communication system provided with a control support device according to a fourth embodiment. A communication system 200 illustrated in this drawing includes a vehicle control device 1B as an apparatus control device, and a control support device 11. The vehicle control device 1B and the control support device 11 are communicably connected via a communication network 201. The vehicle control device 1B can be connected to the communication network 201 by wireless communication. The communication network 201 is constituted by, for example, one or a combination of a local area network (LAN), a wide area network (WAN), a public line, a virtual private network (VPN), a dedicated line and the like. For the communication network 201, wired communication and wireless communication are combined as appropriate.

The vehicle control device 1B has an input unit 2, a sensor group 3, a control unit 4B, a storage unit 5B and a communication unit 6. Hereinafter, components having the similar functions to the components of the vehicle control device 1 described in the first embodiment will be denoted by the same reference signs as that of the components of the vehicle control device 1 to be described.

The control unit 4B has a data acquisition unit 41, a prediction unit 42 and a timer 45. The control unit 4B is a processor constituted by, alone or in combination, a CPU or hardware such an FPGA.

The storage unit 5B has a learned model storage unit 51 and an engine state storage unit 55. The storage unit 5B is constituted by using hardware such as a ROM and a RAM. The communication unit 6 is an interface that communicates with the control support device 11 via the communication network 201 under the control of the control unit 4B.

The control support device 11 includes a communication unit 7, a control unit 8 and a storage unit 9. The control support device 11 performs machine learning using a neural network based on input parameters sent from the vehicle control device 1B to generate a second learned model as well as determines a learned model used by the prediction unit 42 of the vehicle control device 1B and transmits at least the determination result to the vehicle control device 1B.

The communication unit 7 is an interface that communicates with the vehicle control device 1B via the communication network 201 under the control of the control unit 8.

The control unit 8 has a data acquisition unit 81, a learning unit 82 and a determination unit 83. The data acquisition unit 81 acquires an input/output data set received by the communication unit 7 from the vehicle control device 1B. The learning unit 82 and the determination unit 83 have the similar functions to the learning unit 43 and the determination unit 44 described in the first embodiment, respectively. When the use of the second learned model has been determined, the determination unit 83 performs the control to transmit, to the vehicle control device 1B, the second learned model stored in a learned model storage unit 91 of the storage unit 9. The control unit 8 is a processor constituted by, alone or in combination, a CPU and/or hardware such an FPGA.

The storage unit 9 has the learned model storage unit 91, a selection condition storage unit 92, a data set storage unit 93, and a learning data storage unit 94. These store the similar data to that in the learned model storage unit 51, the selection condition storage unit 52, the data set storage unit 53, and the learning data storage unit 54 described in the first embodiment, respectively. The storage unit 9 is constituted by using hardware such as a ROM and a RAM.

According to the fourth embodiment described above, similar to the first embodiment, it is possible to accurately support the control of a vehicle having an internal combustion engine in which the control uses the learned model by machine learning.

Moreover, according to this fourth embodiment, since the control support device performs the learning of the second learned model and determination of the learned model used for the vehicle control device to predict, it is possible to perform arithmetic operations faster than that in a case where these arithmetic operations are performed in the vehicle side.

Furthermore, according to this fourth embodiment, since the vehicle control device does not have to generate a learned model or determine a learned model used for the prediction, it is possible to reduce the load of computation and suppress battery power consumption.

Note that the data acquisition unit 81 may perform an arithmetic operation to acquire an input/output data set that needs to be calculated by a predetermined arithmetic operation, such as a fuel amount in oil and power consumption necessary for restart after idle reduction.

Further, the control support device 11 may receive only data such as detection values from the vehicle control device 1B, and the data acquisition unit 81 of the control support device 11 may generate the input/output data set based on the received data. As described above, the control support device 11 performs an arithmetic operation relating to the input/output data set so that it is possible to reduce the load of the computation in the vehicle control device 1B and suppress battery power consumption, while it is possible to quickly generate the input/output data set by the control support device 11 side having high computing capability.

Moreover, the control support device 11 may be equipped with the function of the prediction unit 42, and the result predicted by the control support device 11 may be transmitted to the vehicle control device 1B. In this case, the control support device 11 may further include a map generation unit, the determination unit 83 may determine a map used for the prediction, and the prediction unit may predict using the map determined by the determination unit 83.

Furthermore, the selection condition referred by the determination unit 83 to determine may be the interpolation condition described in the second embodiment or may be a combination of the switching condition and the interpolation condition described in the modification example of the second embodiment.

### Other Embodiments

Hereinbefore, the prediction processing of the power consumption necessary for restart after idle reduction has been described as an example, but the above-described embodiments may also be applied to other vehicle control. For example, in a vehicle equipped with a diesel engine, the embodiments can be applied to prediction processing of a catalyst temperature at the time of particulate matter (PM) reproduction performed to prevent clogging of a diesel particulate filter (DPF). In this case, the prediction unit uses a learned model generated by machine learning using an input/output data set, in which state amounts, such as amount of air, an exhaust gas temperature and a fuel addition amount, are input parameters and a catalyst temperature is an output parameter, to predict the stable catalyst temperature. When the predicted value is higher than the specified temperature, the control unit reduces the fuel addition amount. This makes it possible to increase the catalyst temperature while avoiding overheating of the catalyst.

Moreover, in a case of a diesel engine, the embodiments can also be applied to a technique of controlling the heat generation rate center directed to the improvement of fuel consumption (see, for example, Japanese Laid-open Patent Publication No. 2016-11600). In this case, the prediction unit uses a learned model generated by machine learning using an input/output data set, in which state amounts, such as an amount of air, supercharging pressure and a temperature, and compatible values of a rail pressure, a main injection time period and the like are input parameters and the hear generation rate center is an output parameter, to predict the heat generation rate center. When the predicted value deviates from the specified value of the heat generation rate center, the control unit corrects the prediction value by feedforward control of the fuel injection timing. Accordingly, the delay in feedback control of the combustion parameter that changes the combustion state of each cylinder in order to match the heat generation rate center with the specified value is suppressed, and fuel consumption can be improved. Furthermore, since the heat generation rate center changes depending on the engine machine difference such as a compression ratio, the prediction precision can be improved by using the second learned model generated by the learning of the learning unit.

In addition, the above embodiments can be applied to control of apparatuses other than a vehicle. One example of the apparatuses is an air conditioner. In this case, by using a learned model generated by machine learning using an input/output data set in which a room temperature, humidity, season, date and time and the like are input parameters and an air volume and a wind direction are output parameters, the control under a normal climate is supported. Moreover, in a case of abnormal weather such as a foehn phenomenon or a heat island phenomenon, or a typhoon out of season, a learned model newly generated by an air conditioner cannot ensure the precision so that a learned model set in advance at the time of shipment is used to support the control.

Another example of the apparatuses is a smartphone. In this case, by using a learned model generated by machine learning using an input/output data set in which date and time, classification or address of an article viewed at that date and time and the like are input parameters and an advertisement is an output parameter, the control during the day is supported. Furthermore, in a case of the hours in the middle of the night or the like in which the smartphone is not usually used, a learned model newly generated by the smartphone cannot ensure the precision so that a learned model set in advance at the time of shipment is used to support the control.

In the above description, deep learning using a neural network has been described as one example of machine learning, but machine learning based on other methods may be applied. For example, other supervised learning may be used, such as support vector machines, decision trees, simple Bayes or k-nearest neighbors algorithm. Further, instead of supervised learning, semi-supervised learning may be used.

As the input parameters constituting the input/output data set or part of the learning data, data obtained by, for example, road-to-vehicle communication, vehicle-to-vehicle communication or the like may be used in addition to the data acquired from the sensor group possessed by the vehicle. Moreover, also in a case of a general apparatuses, input parameters may be acquired by using data communication via a communication network.

According to the present disclosure, a learned model is generated by performing machine learning using an input/output data set relating to the internal or external state of an apparatus, and, based on the acquired input parameters and the learning situation of the machine learning, a learned model used for control of the apparatus is determined from a plurality learned models that include a learned model, which has been completely generated, and can be used for the control so that it is possible to select an appropriate learned model to accurately support the control of the apparatus using the learned model by machine learning.

According to an embodiment, it is possible to support highly precise control even when a learned model that has been completely generated is applied to control.

According to an embodiment, it is possible to support highly precise control using a learned model based on input parameters having values within a range acquired by a learning unit during learning.

According to an embodiment, it is possible to support control using a map, reduce a load applied to a device that controls an apparatus, and quickly execute the computation of the device.

According to an embodiment, it is possible to provide a map based on an appropriate learned model according to a range of values of input parameters.

According to this, it is possible to generate a highly precise learned model based on deep learning.

According to an embodiment, even when learning data has a variation in density, nodes of a neural network are used also in a sparse portion, and it is possible to suppress a decrease in prediction precision in the sparse portion.

According to an embodiment, it is possible to accurately control an apparatus since the control is performed using a value obtained by quantifying a predetermined state of an apparatus by a learned model.

According to an embodiment, it is possible to accurately support control of a vehicle itself in the vehicle.

According to an embodiment, since the apparatus control device does not have to generate a learned model or determine a learned model used for control, it is possible to reduce the load of computation and suppress battery power consumption.

According to an embodiment, since the apparatus control device does not have to generate input/output parameters or a learned model or determine a learned model used for control, it is possible to reduce the load of computation and suppress battery power consumption.

According to an embodiment, since learning is performed while an input/output data set is acquired, it is possible to accelerate the application of a learned model generated by a learning unit and provide accurate support early.

According to an embodiment, since it is not necessary to generate a learned model or determine a learned model used for control, it is possible to reduce the load of computation, suppress battery power consumption, and even receive support for accurately controlling an apparatus from the control support device.

According to an embodiment, it is possible to provide a learned model generated based on deep learning using a neural network and accurately support control of an apparatus using the learned model.

According to an embodiment, it is possible to provide a learned model that accurately supports control of an apparatus.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.F

What is claimed is:

1. A control support device which supports control of an apparatus by using a learned model by machine learning, the control support device comprising:
a data acquisition unit configured to acquire an input/output data set which are data relating to an internal or external state of the apparatus and including input parameters and an output parameter of the learned model;
a learning unit configured to generate a learned model by performing the machine learning using the input/output data set acquired by the data acquisition unit; and
a determination unit configured to determine a learned model which is to be used for the control from among a plurality of learned models, which include a learned model having been completely generated and can be used for the control, based on the input parameters acquired by the data acquisition unit and a learning situation of the machine learning in the learning unit.

2. The control support device according to claim 1, wherein the determination unit is configured to select the learned model when the learning situation meets a condition that satisfied a precision of the learned model that has been completely generated.

3. The control support device according to claim 2, wherein the condition is that at least any one of the input parameters input for the control is data having a value within a range acquired during learning by the learning unit.

4. The control support device according to claim 1, further comprising a map creation unit configured to create a map that associates the input parameters with the output parameter by using the learned model that has been completely generated and a learned model that has been generated in advance when the determination unit determines a use of the learned model that has been completely generated by the learning unit.

5. The control support device according to claim 4, wherein the map creation unit is configured to associate input parameters with an output parameter of different learned models according to a range of values of the input parameters.

6. The control support device according to claim 1,
wherein the learning unit is configured to perform the machine learning by using a neural network, which includes: an input layer into which the input parameters are input; an intermediate layer into which signals output by the input layer are input and which has a multilayer structure; and an output layer into which signals output by the intermediate layer are input and which outputs an output parameter, where each of the layers includes one or a plurality of nodes, and
update and learn network parameters of the neural network based on the output parameter output by the output layer according to input of the input parameters into the input layer and the output parameter included in the input/output data set.

7. The control support device according to claim 6, wherein the learning unit is configured to learn by decreasing a number of the input parameters included in a region where a frequency of acquiring values of the input parameters is higher than a predetermined reference.

8. The control support device according to claim 6,
wherein processing of controlling the apparatus by using the learned model
inputs the input parameters acquired by the data acquisition unit into the input layer,
performs an arithmetic operation based on the network parameters that have been learned, and
outputs the output parameter, which is obtained by quantifying a predetermined state of the apparatus, from the output layer.

9. The control support device according to claim 1,
wherein the apparatus is a vehicle that has an internal combustion engine, and
the control support device is mounted in the vehicle.

10. The control support device according to claim 1, further comprising: a communication unit configured to transmit and receive information via a communication network to and from an apparatus control device configured to control the apparatus,
wherein the learning unit performs the machine learning based on the input/output data set received by the communication unit from the apparatus control device, and
the communication unit transmits the learned model generated by the learning unit and a determination result of the determination unit to the apparatus control device.

11. The control support device according to claim 1, further comprising: a communication unit configured to transmit and receive information via a communication network to and from an apparatus control device configured to control the apparatus,
wherein the learning unit generates, based on data received by the communication unit from the apparatus control device, an input/output data set to perform the machine learning and
performs the machine learning based on the input/output data set, and
the communication unit transmits the learned model generated by the learning unit and a determination result of the determination unit to the apparatus control device.

12. The control support device according to claim 1, wherein the learning unit and the determination unit perform processing in parallel.

13. A apparatus control device configured to communicate with a control support device, which is configured to support control of an apparatus, and control the apparatus by using a learned model by machine learning,
wherein the control support device comprises:
a learning unit configured to generates a learned model by performing the machine learning using an input/output data set which is data relating to an internal or external state of the apparatus and including input parameters and an output parameter of the learned model; and
a determination unit configured to determine a learned model used for the control from among a plurality of learned models that include a learned model, which has been completely generated, and can be used for the control, based on the input parameters and a learning situation in the learning unit, and
the apparatus control device comprises:
a data acquisition unit configured to acquire the input/output data set; and
a communication unit configured to transmit the input/output data set acquired by the data acquisition unit to the control support device and receive at least a determination result by the determination unit from the control support device.

14. A control support method executed by a control support device configured to support control of an apparatus by using a learned model by machine learning, the method comprising:
a data acquisition step of acquiring an input/output data set which is data relating to an internal or external state of the apparatus and including input parameters and an output parameter of the learned model;
a learning step of reading out from a storage unit the input/output data set acquired in the data acquisition step and generating a learned model by performing the machine learning using the input/output data set read out; and
a determination step of determining a learned model used for the control from among a plurality of learned models that include a learned model, which has been completely generated, and can be used for the control, based on the input parameters acquired in the data acquisition step and a learning situation of the machine learning.

15. A non-transitory computer-readable recording medium storing a control support program causing a control support device, which is configured to support control of an apparatus by using a learned model by machine learning, to execute:
a data acquisition step of acquiring an input/output data set which is data relating to an internal or external state of the apparatus and including input parameters and an output parameter of the learned model;
a learning step of reading out from a storage unit the input/output data set acquired in the data acquisition step and generating a learned model by performing the machine learning using the input/output data set read out; and
a determination step of determining a learned model used for the control from among a plurality of learned models that include a learned model, which has been completely generated, and can be used for the control, based on the input parameters acquired in the data acquisition step and a learning situation of the machine learning.

16. A learned model generated from a neural network, which comprises:
an input layer into which input parameters obtained by quantifying an internal or external state of an apparatus are input;
an intermediate layer into which signals output by the input layer is input and which has a multilayer structure; and
an output layer into which signals output by the intermediate layer is input and which outputs an output parameter obtained by quantifying a predetermined state of the apparatus, in which each of the layers includes one or a plurality of nodes,
wherein the learned model causes a computer to function so as to input the input parameters into the input layer, perform an arithmetic operation based on a learned network parameter which is a network parameter of the neural network, and output a value obtained by quantifying a predetermined state of the apparatus from the output layer.

17. A method of generating a learned model for generating a learned model for causing a computer to function so as to output a value obtained by quantifying a predetermined state of an apparatus,
wherein the computer uses a neural network comprising: an input layer into which input parameters obtained by quantifying an internal or external state of the apparatus are input; an intermediate layer into which signals output by the input layer are input and which has a multilayer structure; and an output layer into which signals output by the intermediate layer is input and which outputs an output parameter, in which each of the layers includes one or a plurality of nodes, to learn while updating a network parameter of the neural network based on the output parameter output by the output layer according to input of the input parameters and an output parameter constituting an input/output data set together with the input parameters and storing the network parameter in a storage unit.
